(19) United States
(12) Patent Application Publication
(10) Pub. No.: US 2008/0249833 A1
(43) Pub. Date: Oct. 9, 2008

(54) Method and system for targeted advertising via mobile terminals

(76) Inventors: Asif Ali, Chennai (IN); Tarandeep S. Uppal, Gardena, CA (US)

Correspondence Address: Lester H. Birnbaum, 6 Oakmont Court, Simpsonville, SC, 29681, US

(21) Appl. No.: 11/732,779

(22) Filed: Apr. 4, 2007

(51) Int. Cl. G06Q 30/00

(52) U.S. Cl. 705/10; 705/14

(57) ABSTRACT

A method and a system for targeted advertising via mobile terminals are provided. Advertisements and advertising parameters are received from an advertising network. A mobile terminal is selected based on the advertising parameters, user profile information and details of mobile terminals. The advertisement is then sent to the mobile terminal at an appropriate time. The advertisement can be an image, an audio, a video, an audio-video, text, a link to a WAP site, and the like. Further, the advertisement may be sent to the mobile terminal depending on the content of a message being sent.

### BACKGROUND

The invention relates in general to the field of advertising, and in particular, to advertising via mobile terminals.

Advertising is an integral part of any marketing strategy for products or services, since it is an effective way of conveying information about them. The various means of advertising include media such as radio, newspapers, magazines, billboards, banners, television, the Internet, mobile terminals, and the like. Advertising through the television is an effective form of advertising. In addition, with increasing usage of the Internet and the growth of the wireless industry, the Internet and mobile terminals have also proved their effectiveness in creating brand awareness about products and services and conducting business.

Advertising via mobile terminals includes Short Message Service (SMS), wallpapers, mobile TV inserts, and the like. Further, the advertisements may also include a feature of ‘click-to-view’, where the user can click on a hyperlink and view a Wireless Application Protocol (WAP) page for details, or ‘click-to-call’, where the user can click on a phone number on a screen of the mobile terminal to directly call an advertiser, instead of dialing the phone number. Advertisements are usually sent to all the users of mobile terminals or to a specific set of users.

However, advertisements sent by using existing advertising platforms and methods are not precisely targeted and are not relevant. The targeting process does not consider users' preferences. This means that irrespective of different preferences of different users, the same advertisements are sent to all users. Further, advertisements are sent at an inappropriate time. For example, an advertisement may be sent when the user is in a cinema hall watching a movie, an advertisement about sunglasses may be sent in winter, an advertisement for a car test drive may be sent when the showroom is closed, etc. Such irrelevant advertisements may result in users considering the advertisements as ‘spam’. Moreover, these irrelevant advertisements may disturb users when they are busy, for example, in a meeting. Further, most advertisements are convoluted and the interface on the screens of mobile terminals is not user-friendly. For example, if users are interested in acquiring more information about a product being advertised, they need to navigate through a number of pages to visit the website of the advertiser. This wastes users' time and is therefore not beneficial for the advertiser.

In light of the foregoing discussion, there is a need for a method and system that delivers relevant and optimally priced advertisements to targeted sets of users at the right time. Further, the interface on the screens of mobile terminals should be user-friendly to make it convenient for users to view and respond to the advertisements. Additionally, the pricing of the advertisements should be optimal and should reflect the supply and demand characteristics of the users, the advertisers, and the advertisements.

### SUMMARY

An object of the present invention is to provide relevant advertisements to users of mobile terminals.

Another object of the present invention is to provide advertisements to users at an appropriate time.

Another object of the present invention is to wrap advertisements in relevant content viewed by users.

Another object of the present invention is to make it convenient for users to view and respond to advertisements.

Another object of the present invention is to enable advertisers, publishers, and carriers to view and analyze the results of advertising campaigns.

Another object of the present invention is to enable advertisers to modify their advertising strategies.

Yet another object of the present invention is to enable dynamic pricing of advertisements, based on the supply-demand characteristics of users, advertisers, and advertisements.

To achieve the objectives mentioned above, various embodiments of the present invention provide a method and system for targeted relevant advertising via mobile terminals. In accordance with an embodiment of the present invention, an advertiser provides advertisements and advertising parameters. A database stores details of the mobile terminals and information about the users of these terminals. A mobile terminal is selected, based on the advertising parameters, details of the mobile terminals, and user-profile information. An advertisement is customized, based on the features of the selected mobile terminal, and sent to users at an appropriate time or at regular intervals, so that the users may view and respond to the advertisements.

In another embodiment, relevant advertisements are sent based on the content of the messages received by a mobile terminal. Messages being sent to users of mobile terminal are scanned and advertisements are selected based on details of the messages. The advertisement may be sent separately to a user, or it may be a part of a message, based on the bandwidth availability in the message.

The pricing of advertisements is calculated based on the weight of the words used in the advertisements, the target population, and relative pricing of keywords in other channels such as Google™, Yahoo!™, etc. Advertisers may view and analyze advertising details such as the pricing of advertisements, the money spent, the number of advertisements clicked on by users, etc., on a web portal. Advertisers may also modify their advertising strategies, based on their analyses.

Hence, relevant advertisements are sent to targeted sets of users at an appropriate time, based on the preferences of individual users. Further, users may view and respond to advertisements by using a convenient user interface.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram of an environment in which various embodiments of the present invention may be practiced;

FIG. 2 is a block diagram of a system for targeted advertising via mobile terminals, in accordance with an embodiment of the present invention;

FIG. 3 is a block diagram of a system for targeted advertising via mobile terminals, in accordance with another embodiment of the present invention;

FIG. 4 is a flowchart of a method for targeted advertising via mobile terminals, in accordance with an embodiment of the present invention;

FIG. 5 is a flowchart of a method for targeted advertising via mobile terminals, in accordance with another embodiment of the present invention.

### DESCRIPTION OF PREFERRED EMBODIMENTS

Various embodiments of the present invention provide a method and a system for targeted and relevant advertising via mobile terminals. The system delivers relevant advertisements to a relevant set of mobile terminals at an appropriate time by using advertising parameters and details of mobile terminals, as well as the preferences of the users of the mobile terminals. In an embodiment of the present invention, an advertisement is sent based on the content of a message received by a user. The advertisement may also be a part of a message sent to the user.

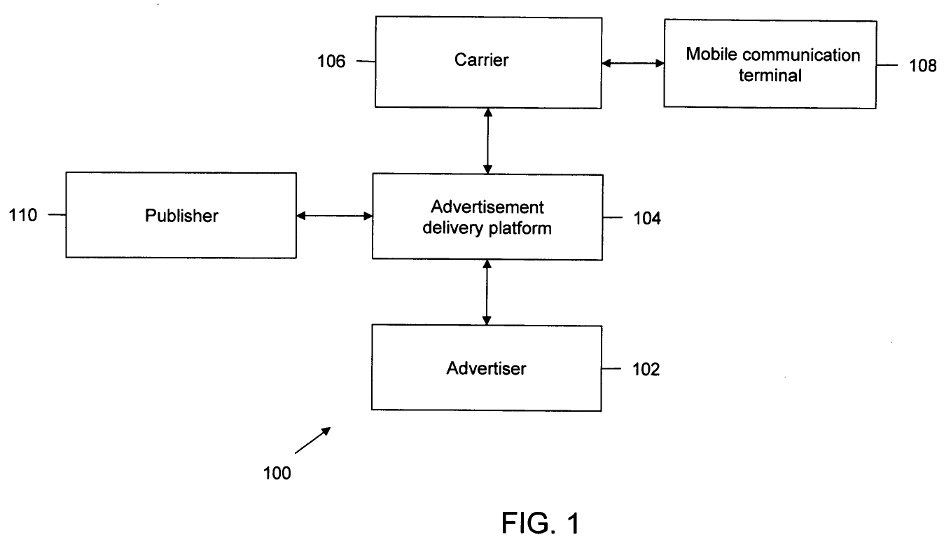

FIG. 1 is a block diagram of an environment 100 in which various embodiments of the present invention may be practiced. Environment 100 includes an advertiser 102, an advertisement delivery platform 104, a carrier 106, a publisher 110, and a mobile communication terminal 108. Mobile communication terminal 108 is hereinafter referred to as mobile terminal 108. Environment 100 is also referred to as an advertising network. Advertiser 102 provides advertisements and advertising parameters, such as the type of users and the geographies to be targeted, to advertisement delivery platform 104. Advertisement delivery platform 104 selects mobile terminal 108 based on the advertising parameters and details of mobile terminal 108, including preferences of its user. Thereafter, advertisement delivery platform 104 sends the advertisements to mobile terminal 108 via carrier 106. The advertisements may be sent separately or as a part of the content provided by publisher 110. These advertisements may be any one of an image, an audio, a video, a Wireless Application Protocol (WAP) link to an advertiser's website, text, holographic 3-dimensional (3D), an animation, a static image, a wall paper, and the like.

In accordance with various embodiments of the invention, advertiser 102 may be an advertising agency, a merchant of a product, and the like. Carrier 106 is a network service provider such as Verizon Wireless. Mobile terminal 108 may be a mobile phone, a Personal Digital Assistant (PDA), and the like. Publisher 110 may be a provider of content such as ring tones, stock quotes, music, jokes, and the like. Examples of publishers may include, but are not limited to, a mobile Internet site developer, a game developer, an application developer, a Short Message Service (SMS) premium service provider, and the like. For example, an advertisement may be a part of a chat between two users using Yahoo Messenger, with Yahoo Messenger being the publisher in this case.

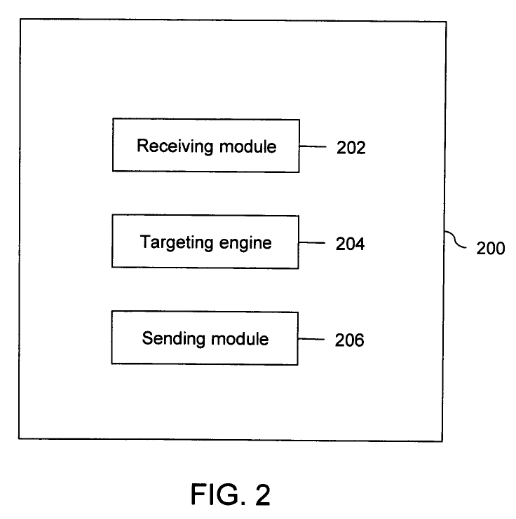

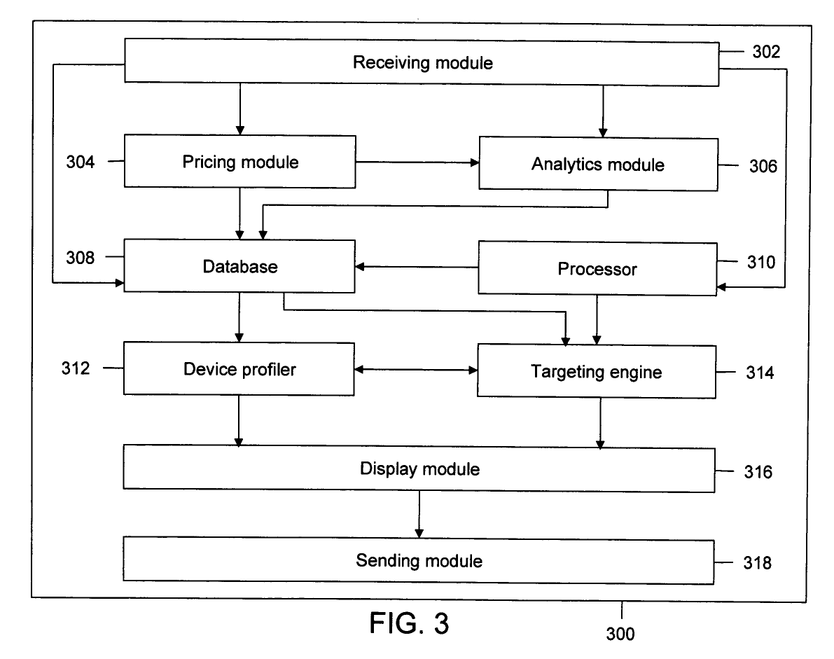

Advertisement delivery platform 104 is based on Service-Oriented Architecture (SOA) and can support networks such as Global System for Mobile Communications (GSM), Code Division Multiple Access (CDMA), and the like. Advertisement delivery platform 104 supports targeting and relevance of advertisements and sends advertisements, based on the advertising parameters and details of mobile terminals. Hence, relevant advertisements are sent to a relevant set of users at an appropriate time. Advertisement delivery platform 104 is described in detail in conjunction with FIG. 2 and FIG. 3.

FIG. 2 is a block diagram of a system 200 for targeted advertising via mobile terminals, in accordance with an embodiment of the present invention. System 200 is advertisement delivery platform 104 in more detail and includes a receiving module 202, a targeting engine 204, and a sending module 206. Receiving module 202 receives advertisements and advertising parameters provided by advertiser 102. These advertising parameters include details provided by advertiser 102 regarding the users to whom the advertisements should be sent. Receiving module 202 forwards the advertisements and advertising parameters to targeting engine 204. Targeting engine 204 maps the advertising parameters with details of available mobile terminals, and accordingly, selects mobile terminal 108. Sending module 206 sends the advertisements to mobile terminal 108.

In accordance with various embodiments of the present invention, the advertising parameters provided by advertiser 102 may include the spending and purchasing patterns, the credit worthiness and the preference settings of a user of mobile terminal 108, as well as content of the advertisement, demographic details, environmental factors, and the like. The spending and purchasing patterns of the user may be obtained by monitoring online transactions made by the user by using mobile terminal 108. The credit worthiness of the user may be established by knowing income of the user, tracking bills of mobile terminal 108, and the like. For example, a Mercedes Benz car advertisement may be sent to a user with an annual income over USD 100K. The preference settings of a user refer to types of applications installed on mobile terminal 108. For example, an advertisement related to the release of a new movie may be sent to users having a song from a movie as their ring tones. The content of the advertisement refers to the product or service being advertised, while the demographic details refer to information pertaining to users, such as a location that advertiser 102 wants to target. For example, advertiser 102 may want to advertise a new Reebok outlet in New York only to users residing in New York. Environmental factors refer to weather conditions, temperature, and the like. For example, advertiser 102 may want to advertise ski resorts, but only in winter. The details of mobile terminal 108 include status of mobile terminal 108, its type, profile, preference settings, location, user actions, and the like.

In accordance with various embodiments of the invention, advertisement delivery platform 104 supports a ‘push’ model for advertisements. For example, advertiser 102 may want advertisements pertaining to vacant seats on a Jet Airways flight to be sent to users who have traveled by Jet Airways in the past two months. The advertisements may then be pushed to the mobile terminals of such users. In addition, advertisement delivery platform 104 supports a ‘pull’ model for advertisements. For example, advertisements relating to games and sports may be sent to the user only when the user is playing a game on mobile terminal 108.

FIG. 3 is a block diagram of a system 300 for targeted advertising via mobile terminals, in accordance with another embodiment of the present invention. System 300 is advertisement delivery platform 104 in more detail and includes a receiving module 302, a pricing module 304, an analytics module 306, a database 308, a processor 310, a device profiler 312, a targeting engine 314, a display module 316, and a sending module 318.

Receiving module 302 receives advertisements and advertising parameters from an advertiser such as advertiser 102. Receiving module 302 is similar to receiving module 202. Analytics module 306 analyzes the advertising parameters and advertisements, and stores the details in database 308. For example, details such as the type, number of advertisements clicked, the advertising parameters etc., are stored. Processor 310 monitors mobile terminals located in a particular geographical region at pre-defined time intervals. Herein, monitoring includes tracking user actions, as well as the type, status, location of the mobile terminal, and the like. Database 308 also stores the details of mobile terminals thus obtained and the details provided by the user. In addition, user profile information is also stored. Targeting engine 314 selects mobile terminals to which the advertisement is to be sent, based on the advertising parameters and details of mobile terminals. Device profiler 312 customizes the advertisement, based on details such as the type and preference settings of the selected mobile terminals. Display module 316 wraps the customized advertisement before sending it to the selected mobile terminal. Display module 316 enables a user to view and respond to the advertisement when it is displayed on the mobile terminal. Sending module 318 sends the advertisement to the selected mobile terminal. Pricing module 304 generates the prices of the advertisements, based on the words used in the advertisements etc., so that advertiser 102 can view it.

In accordance with various embodiments of the invention, analytics module 306 analyzes advertising details and results of advertising campaigns. These advertising details may include the type of advertisements, the pricing, the money spent, the number of advertisements served, the number of advertisements clicked on, the number of offers redeemed, the list of publishers, the number of users who have subscribed for the advertisements, offers on different products, and the like. The advertising details may be viewed on a web portal. Advertiser 102 and carrier 106 may view the advertising details by using analytics module 306. Further, analytics module 306 enables advertiser 102 to modify advertising strategies. For example, advertiser 102 may observe that advertisements sent to users residing in New York and after 11 pm are not proving beneficial. Advertiser 102 may then refine his advertising strategy by sending the advertisements to the users between 8 pm and 11 pm.

Carrier 106 may view advertisement statistics such as the number of advertisements served and the number of users who have responded to the advertisements. Users can view offers on products, rewards, and promotions that are sent through the advertisements. In various embodiments of the present invention, an administrator may manage analytics module 306. For example, the administrator may block or approve advertiser 102 and the advertisements. The administrator may also have permission to view the list of subscribers for the advertisements, the list of advertisers providing the advertisements, the list of publishers publishing the advertisements, the revenue reports generated, and the like. In one embodiment, the administrator may set filtering rules. For example, the administrator may list words such as ‘politics’, ‘pom’, etc., which are not allowed to appear in the advertisements. If an advertisement provided by advertiser 102 contains the word politics, the advertisement is blocked and advertiser 102 is notified accordingly.

Database 308 also maintains user profile information which includes the age, gender, contact number, profession, annual income, location, etc., of the user. In an embodiment of the present invention, user profile information may include the type of advertisements viewed by the user, the type of advertisements to which the user has responded, the type of advertisements about which the user has requested more information, the type of response of the user, and the like. The user profile information may be obtained from data collected during registration of mobile terminal 108. The details stored in database 308 may be updated after pre-defined intervals of time, for example, a month.

Processor 310 monitors details of mobile terminals like mobile terminal 108, which include the status and type of mobile terminal 108, its profile, user actions, location, and the like. The status of mobile terminal 108 refers to whether mobile terminal 108 is active or switched off. For example, if mobile terminal 108 is not active, the advertisement may not be sent instantly to mobile terminal 108. The status may also refer to whether mobile terminal 108 is currently handling a call. For example, advertiser 102 may want advertisements to be sent to mobile terminal 108 whenever a call ends. The type of mobile terminal 108 refers to its cost and the features supported by it. Advertisements may be sent to mobile terminal 108 in a suitable format, based on the features supported by it. For example, advertisements in a video form are sent to mobile terminal 108, only if it supports a video format. The profile of mobile terminal 108 refers to settings of the mobile terminal. Examples of profile include silent, general, outdoor, loud, and the like. For example, if the current profile of mobile terminal 108 is ‘silent’, it may be inferred that the user is busy and the advertisement should not be sent immediately.

User actions refer to actions performed by users of mobile terminal 108. For example, if the user is downloading a wallpaper of a baseball player, it may be inferred that the user is interested in baseball, and an advertisement about a discount on baseball bats may be sent to the user. If the user is listening to a song online, it may be inferred that the user is interested in songs, and an advertisement regarding a discount on music players may be sent to the user. Location details refer to the location of mobile terminal 108. Location Based System (LBS), Global Positioning System (GPS), Cell Broadcast Channel (BCCH), and the like, may be used to obtain the location of mobile terminal 108. The location details may also include the IP address of a terminal. In an embodiment, the user may provide the details of mobile terminal 108 when the user subscribes to receive the advertisements on mobile terminal 108. In another embodiment, carrier 106 may provide the details of mobile terminal 108 using information obtained during registration of mobile terminal 108.

A device profiler 312 customizes the advertisement based on the details of the mobile terminal to which the advertisement is sent. In an embodiment, customization of the advertisement may be performed dynamically. For example, advertisements sent to two different phone models are modified, based on screen size. In an embodiment, the preferences of the user of mobile terminal 108 may also be used to customize the advertisement. For example, the user of mobile terminal 108 may want an advertisement to be displayed at the top of the screen, while another user may want the advertisement to be displayed at the bottom of the screen, or at any other specific position on the mobile terminal.

Display module 316 displays the advertisement to the user, along with a set of options, which enables the user to respond to the advertisement. This set of options includes view, hide, save, forward, delete, and exit. The options enable users to view an advertisement whenever they wish to, thereby making it non-intrusive. Forwarding the advertisement to other users helps to create a ‘viral’ effect. Display module 316 may be an application that wraps the advertisement and displays the advertisement on mobile terminal 108. For example, the content of the advertisement may be included in an executable file and then displayed on mobile terminal 108. In an embodiment, options of click-to-call, click to opt-in to an email, click-to-land at a WAP microsite, click-to-land at an existing WAP site, click-to-locate, and click-to-subscribe to an SMS/WAP opt-in may also be displayed to the user. The user interface of the advertisements may be Web 2.0, Ruby or AJAX, and the like. In another embodiment, the user may be provided with the option of navigating to a WAP site or an SMS short code system to post a response. For example, if the user navigates the WAP site, an advertisement displayed on the WAP site may include a response form for the user.

Sending module 318 sends the advertisement to mobile terminal 108. The advertisement may be first stored in a cache on mobile terminal 108 before being displayed. The cache may be a flash memory, a memory card, and the like.

In accordance with an embodiment of the invention, an advertisement may be sent based on the content of the message received by mobile terminal 108. For example, if the message contains the latest score of an ongoing cricket match, an advertisement relating to the free delivery of tickets for cricket matches may be sent to mobile terminal 108.

In accordance with an embodiment of the present invention, pricing module 304 generates the prices of advertisements, based on offers for impressions, the weight of words used in the advertisements, the number of interactions of the user that pertain to the advertisements, the target audience of the advertisements, and the like. An impression refers to each individual page view on a mobile publisher's website. Interactions refer to clicking of an advertisement to get additional information on an advertised product or to accept an offer. The weight of words refers to frequency of words being used in the advertisement. The pricing of words may be calculated by using the advertiser's advertising history, user profile, supply and demand of advertisement inventory, and the like. For example, if an advertisement needs to be sent only to male users, the price of the advertisement may be twice the normal price because target audience is half the normal number.

In accordance with various embodiments of the present invention, various modules of system 300, such as receiving module 302, pricing module 304, analytics module 306, database 308, processor 310, device profiler 312, targeting engine 314, display module 316 and sending module 318, may be implemented as software modules, hardware modules, firmware, and combinations thereof.

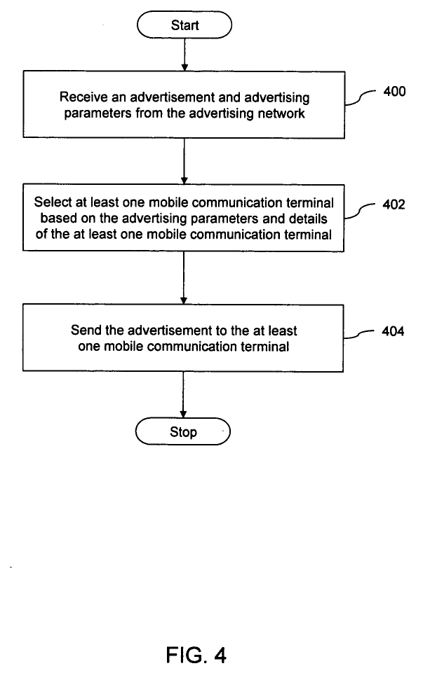

FIG. 4 is a flowchart of a method for targeted advertising via mobile terminals, in accordance with an embodiment of the present invention. At step 400, advertisements and advertising parameters are received from an advertising network. The advertisement may be any one of an image, an audio, a video, a Wireless Application Protocol (WAP) link to an advertiser's website, text, holographic 3-dimensional (3D), an animation, a static image, a wall paper, and the like. The advertising parameters provide details about the target audience to which the advertisements need to be sent as well as the type of advertisement. The advertising parameters may also specify when the advertisements should be sent to the users. At step 402, a mobile terminal like mobile terminal 108 is selected, based on the advertising parameters and details of the mobile terminal, which include the status, type, profile, user actions, location, etc., of the mobile terminal. At step 404, the advertisement is sent to the mobile terminal. In accordance with an embodiment of the invention, the advertisement is stored on the mobile terminal in a cache and is thereafter displayed on the screen of the mobile terminal. The user may view and respond to the advertisement. The method is explained with the help of the following example.

An advertiser may want to advertise a discount offer on Mercedes Benz cars during the time period April to June. The advertisement is a Multimedia Messaging Service (MMS) type of advertisement. Herein, the advertising parameters provided by the advertiser include users with an annual income exceeding $100K, users located in New York, users who download wallpapers of Formula 1 cars, etc. The advertisement delivery platform of the invention thereafter maps the advertising parameters with details of mobile terminals and user profile information stored in the database. The targeting engine selects relevant mobile terminals that can receive MMS advertisements, are located in New York, and have users with an annual income exceeding USD 100K. The advertisement is sent to the relevant mobile terminals at an appropriate time, for example, only when Mercedes Benz car showrooms are open. The advertisement also enables users to respond to the advertisement. For example, if users are busy, they may save the advertisement and view it later. The pricing of the advertisement may depend on the profile of the users to whom it is going to be sent, the type of advertisement, etc.

Advertising campaigns may also be executed by using advertisement delivery platform 104. For example, an advertiser may want to have an advertising campaign for a new clothing line being launched by Versace. The advertising parameters may include users with an annual income exceeding $50K, users who own a Mercedes Benz car, etc. The advertisement may need to be transmitted every five hours to the users. The advertisement delivery platform of the present invention thereafter maps the advertising parameters with details of mobile terminals and information about users of the mobile terminals. The same advertisement is then sent to a targeted set of users every five hours, as a part of the advertising campaign. However, if a user is busy, for example, in the vicinity of a cinema hall, the advertisement is not sent. In this case, the user's location is used to determine when to send the advertisement to the user.

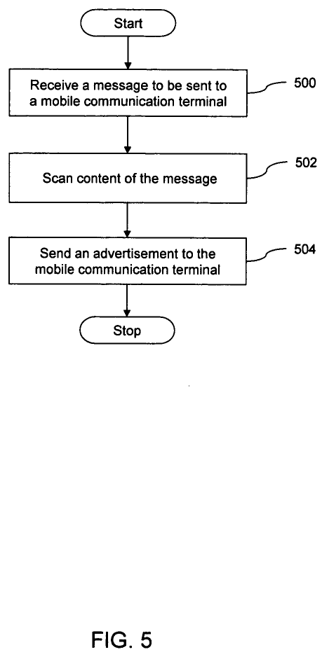

FIG. 5 is a flowchart of a method for targeted advertising via mobile terminals in accordance with an alternative embodiment of the present invention. At step 500, a message being sent to a mobile terminal is received. The message may be an image, an audio, a video, text, a WAP link to an advertiser's website, text, holographic 3-dimensional (3D), an animation, a static image, a wall paper, and the like. It is then checked whether the recipient of the message has subscribed to receive advertisements via advertisement delivery platform 104. If the recipient has not subscribed, the message is not scanned and is forwarded to the recipient immediately. If the recipient has subscribed to receive the advertisements, the message is scanned at step 502. Thereafter, the advertisement is sent to mobile terminal 108 at step 504, based on the content of the message and the details of the mobile terminal. In an embodiment, the advertisement may be appended to the message, if the message has unused bandwidth, and then sent to the recipient. The advertisement may also be a part of a mobile application the user is using or downloading, etc.

For example, an advertiser may want to send advertisements regarding a special offer on movie tickets to users who receive messages with the words ‘movie’ or ‘holiday’, or users who exchange movie clips. Messages are received by the advertisement delivery platform before they reach the recipient of the message. Thereafter, when a user sends a movie clip in a message to another user, it is checked whether the recipient has subscribed to receive advertisements. The message is scanned by the advertisement delivery platform only if the recipient is a subscriber. The advertisement is then sent to the recipient.

The various modules of the present invention are provided as Application Programming Interfaces (APIs). They may be present at the advertiser's end, at the publisher's end, or as a separate entity in the advertising network. For example, if they are installed at the advertiser's end, the advertiser may integrate or interface other applications with the advertisement delivery platform of the present invention by using minimal programming.

The method and system of the present invention or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

The computer system comprises a computer, an input device, a display unit and the Internet. The computer also comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, etc. The storage device can also be other similar means for loading computer programs or other instructions into the computer system. Furthermore, the computer system includes a communication unit that enables the computer to connect to other databases and the Internet through an I/O interface. The communication unit enables the transfer and reception of data from other databases. The communication unit may include a modem, an Ethernet card, or any other similar device that enables the computer system to connect to databases and networks such as LAN, MAN, WAN, and the Internet. The computer system facilitates inputs from a user through an input device that is accessible to the system through an I/O interface.

The computer system executes a set of instructions that are stored in one or more storage elements to process input data. These storage elements may hold data or other information, as desired, and may also be in the form of an information source or a physical memory element present in the processing machine.

The set of instructions may include various commands that instruct the processing machine to perform specific tasks such as the steps constituting the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. Processing of input data by the processing machine may be in response to user commands, the result of previous processing, or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for targeted advertising, the method comprising:
a. receiving an advertisement and advertising parameters from an advertising network, the advertisement being at least one of an image, an audio, a video and a link to a Wireless Application Protocol (WAP) site;
b. selecting at least one mobile communication terminal based on the advertising parameters and details of the at least one mobile communication terminal; and
c. sending the advertisement to the at least one mobile communication terminal.

2. The method of claim 1, wherein the advertising parameters comprise at least one of spending pattern of a user of the at least one mobile communication terminal, purchasing pattern of the user, credit worthiness of the user, preference settings of the user, content of the advertisement, demographic details, environmental factors, and combinations thereof.

3. The method of claim 1, wherein the details of the at least one mobile communication terminal comprise at least one of a type of the at least one mobile communication terminal, user profile information, user actions, profile of the at least one mobile communication terminal, demographic details, location, and combinations thereof.

4. The method of claim 1 further comprising receiving the details of the at least one mobile communication terminal at pre-defined time intervals.

5. The method of claim 1, wherein the advertisement comprises text messages.

6. The method of claim 1 further comprising the step of storing the advertisement in a cache on the at least one mobile communication terminal before displaying the advertisement on the at least one mobile communication terminal.

7. The method of claim 1, wherein the advertisement is sent to the at least one mobile communication terminal at pre-defined time intervals.

8. A method for targeted advertising, the method comprising:
a. receiving a message, the message comprising at least one of an image, an audio, a video, and a link to a Wireless Application Protocol (WAP) site, the message being sent to a mobile communication terminal operating in a wireless network;
b. scanning content of the message;
c. sending an advertisement to the mobile communication terminal based on the content of the message and details of the mobile communication terminal.

9. The method of claim 8 further comprising appending the advertisement to the message before sending the message to the mobile communication terminal.

10. The method of claim 8 wherein the details of the mobile communication terminal comprise at least one of a type of the mobile communication terminal, user profile information, user actions, profile of the mobile communication terminal, demographic details, location, and combinations thereof.

11. A system for targeted advertising, the system comprising:
a. a receiving module, the receiving module receiving an advertisement and advertising parameters from an advertising network, the advertisement being at least one of an image, an audio, a video, text, and a link to a Wireless Application Protocol (WAP) site;
b. a targeting engine, the targeting engine selecting at least one mobile communication terminal based on the advertising parameters and details of the at least one mobile communication terminal; and
c. a sending module, the sending module sending the advertisement to the at least one mobile communication terminal.

12. The system of claim 11, wherein the system is based on Service-Oriented Architecture (SOA) standards.

13. The system of claim 11 further comprising a database, the database maintaining user profile information.

14. The system of claim 11 further comprising a device profiler, the device profiler customizing the advertisement based on the advertising parameters and the details of the at least one mobile communication terminal.

15. The system of claim 11 further comprising a processor, the processor monitoring the details of the at least one mobile communication terminal.

16. The system of claim 11, wherein the details of the at least one mobile communication terminal comprise at least one of status of the at least one mobile communication terminal, user actions, demographic details, location details, and profile of the at least one mobile communication terminal.

17. The system of claim 11, wherein the advertising parameters comprise at least one of spending pattern of a user of the at least one mobile communication terminal, purchasing pattern of the user, credit worthiness of the user, preference settings of the user, content of the advertisement, demographic details, environmental factors, and combinations thereof.

18. The system of claim 11 further comprising a display module, the display module displaying content of the advertisement to a user of the at least one mobile communication terminal.

19. The system of claim 18, wherein the display module enables the user to respond to the advertisement.

20. The system of claim 11 further comprising an analytics module, the analytics module analyzing details related to advertising.

21. The system of claim 20, wherein the analytics module enables at least one of an advertiser and a publisher to modify advertising strategies.

22. The system of claim 11 further comprising a pricing module, the pricing module generating a price for the advertisement based on weights of words used in the advertisement.

23. A computer program product for use with a computer, the computer program product comprising a computer usable medium having a computer readable program code embodied therein for targeted advertising, the computer readable program code performing:
a. receiving an advertisement and advertising parameters from an advertising network, the advertisement being at least one of an image, an audio, a video, and a Wireless Application Protocol (WAP) site;
b. selecting at least one mobile communication terminal based on the advertising parameters and details of the at least one mobile communication terminal; and
c. sending the advertisement to the at least one mobile communication terminal.

24. The computer program product of claim 23, wherein the advertising parameters comprise at least one of spending pattern of a user of the at least one mobile communication terminal, purchasing pattern of the user, credit worthiness of the user, preference settings of the user, content of the advertisement, demographic details, environmental factors, and combinations thereof.

25. The computer program product of claim 23, wherein the details of the at least one mobile communication terminal comprise at least one of a type of the at least one mobile communication terminal, user profile information, user actions, profile of the at least one mobile communication terminal, demographic details, location, and combinations thereof.
